(19) United States
(12) Patent Application Publication
(10) Pub. No.: US 2006/0103806 A1
(43) Pub. Date: May 18, 2006

(54) Non-progressive multi-focal lens with large near/intermediate area

(75) Inventor: Jon Torrey, Portland, OR (US)

Correspondence Address: Mark A. Litman & Associates, P.A.;York Business Center, Suite 205, 3209 W. 76th St., Edina, MN, 55435, US

(73) Assignee: PRIO Corporation

(21) Appl. No.: 10/990,358

(22) Filed: Nov. 16, 2004

(51) Int. Cl. G02C 7/02

(52) U.S. Cl. 351/159

(57) ABSTRACT

A non-progressive ophthalmic lens used in eye frames is provided with at least two and preferably only two distinct areas of prescription. A very large lower area (lower relative to the face and eyes of the wearer) is provided with intermediate or near distance vision correction prescription. A smaller, top portion of the lens is provided with a stable power, containing the wearer's prescription (or non-prescription of zero power) for distance vision correction. The two powers preferably meet at a lined intersection to conserve space that would be consumed by a progressive joining or blending of the two powers.

### BACKGROUND OF THE INVENTION

1. Field of the Invention

The present invention relates to the field of ophthalmic lenses, particularly multifocal ophthalmic lenses, and multifocal ophthalmic lenses worn by persons tasking at close quarters to their work, such as computer operators.

2. Background of the Art

The ability of an eye to switch focus from a distant image to a near image depends on the ability of the eye to change its shape. Specifically, certain structures of the eye, such as, for example, the lens, must change its shape or position so that proper focus of light on the retina is achieved. A number of these structures are under muscular control.

The shape of the lens is affected by muscular action. The lens is held in place behind the iris by zonules or suspensory ligaments, which attach to the wall of the eye at the ciliary body. When the ciliary muscles contract, tension on the zonules increases, which allows the lens to increase its curvature and assume a more spheric shape because of its elastic properties.

When light from a distant visual image enters the normal emmetropic eye with a relaxed ciliary muscle, the target is in focus on the retina. However, if the eye is directed at a nearby visual target, the light is initially focused behind the retina, i.e. the image at the retina is blurred, until accommodation occurs. The image is sharpened when the lens becomes thicker with a steeper central curvature because of contraction of the ciliary muscles, resulting in a decreased diameter across the lens as well as its suspensory connections to the wall of the eye via the zonular fibers which become relaxed, allowing the lens to achieve this more spherical shape as needed.

Accommodation refers to the ability of the eye to change its focus. Accommodation is measured by the accommodative amplitude, that is, the power, measured in units called diopters (D), that the lens can vary from the non-accommodative state to a full accommodative state. For example, in accommodation for near vision, the lens increases its curvature, and as such, the amplitude of accommodation increases.

The lens continues to grow throughout an individual's lifetime. The rate of lens growth is usually about 20 to 30 microns per year. As such, the lens diameter increases over time and this increase has been correlated to a decrease in accommodative power and thus, a decrease in the ability of the lens to focus on near images. The gradual loss of accommodative power with age means that individual's ability to focus on near images declines over time. When the near point of accommodation has receded beyond a comfortable distance, the individual is said to have a condition called presbyopia.

In addition to vision impairment, conditions like presbyopia, also cause eye strain, experienced variably as fatigue, pressure behind the eye, brow ache, and generalized discomfort. To focus on an object, individuals with accommodative impairments hold objects at increasing distances from the eye. Eventually, prescription vision correction in the form of reading glasses, bifocals, trifocals, or some form of compromise between distance focus in one eye and near focus in the other, commonly known as monovision, is implemented. Typically, about 3 diopters of accommodation is necessary to read at a comfortable, close-up distance, and about 6 diopters is necessary to permit reading for extended lengths of time without premature fatigue and discomfort setting in.

The necessary correction in ophthalmic lenses varies depending upon the distance of the observed object. Such is the case for presbyopia which, as is well known, mainly leads to lenses having a double or triple focus (so-called bifocal or trifocal lenses), or to lenses wherein the focal distance progressively varies from one point of the lens to another (commonly called progressive lenses).

In the prior art, U.S. Pat. No. 2,310,925 discloses lenses of the bifocal (for distant-vision and near-vision respectively) or trifocal type, U.S. Pat. No. 2,869,422 discloses the invention of progressive lens and U.S. Pat. No. 5,430,504 describes a production technology for the so-called merged lens wherein the jump between two zones with different focuses is dimmed. These documents widely explain methods for producing multifocal lenses and the machining performed on the front face, or convex external face. Since the curvature radius of the concave face generally is uniform, this convex face is the surface on which the different curvature radii selected on the basis of wished powers are introduced, implying lens thickness variations. It is then assumed that the lens everywhere consists of the same transparent, mineral or organic material.

Those lenses often are blamed for their unaesthetic aspect, resulting from strong thickness variations. Another group of methods dispenses from using a single material having the same reflection index in each zone of the optical lens. Such methods then provide for two materials with different reflection indices, whereby an auxiliary small-diameter lens is incorporated, by fusion, into the material of the main, large-diameter lens. This incorporation again is performed on the front face of the main lens. The main lens is designed for distant-vision correction and the auxiliary lens has a complementary correction for near-vision correction. Both corrections essentially are obtained by the relative value of the refraction indices, without requiring any difference of the curvature radii. The variation of the global power is easily made progressive, from one point of the lens to another, by varying the thickness of the layers having different indices.

These lenses however are not free from inconveniences. In particular, passing from the distant-vision to the near-vision causes image jumps that are troublesome, and unavoidable, for the user. In an attempt to attenuate this type of inconvenience, trifocal lenses can be preferred, but again at the expense of the aesthetic aspect, due to sensible thickness variations. The typical correction ranges, in focal distances, extend from 0.3 to 0.5 m for near-vision, from 0.5 to 1 m for intermediate vision and from 2 m to infinity for distant-vision.

U.S. Pat. Nos. 5,847,802 and 5,682,223 describe concentric lens designs for astigmatic presbyopes which comprise at least one surface Which has a circular central portion and a plurality of concentric annular rings with at least three separate optical powers corresponding to a prescription for a patient and corresponding to 1) a basic distance spherical prescription Rx, 2) a near add spherical prescription Rx, and 3) a spherical prescription corresponding to the full, or preferably a fraction of the, cylindrical prescription Rx. An astigmatic presbyopic prescription contains an astigmatic correction, normally in the nature of a cylindrical prescription which specifies both the cylindrical optical power and the orientation of the cylindrical axis. The cylindrical prescription is taken into account in the design of the lens, but not with a cylindrical optical surface. Instead, the present invention recognizes that the brain can effectively discriminate between separate competing images by accepting an in-focus image and rejecting an out-of-focus image. Accordingly, a portion of the lens is provided with a spherical surface corresponding to the cylindrical prescription, or more preferably a fraction of the full cylindrical prescription, and the brain is relied upon to discriminate and accept an in-focus image to compensate for the patient's astigmatism.

U.S. Pat. No. 5,790,226 describes a pair of glasses to be worn by a golfer where one or two of the lenses contain a reconfigured bifocal lens, i.e. bifocal element. The placement of the bifocal element may be determined by the writing hand of the wearer or may be determined by whether the wearer has a right-handed golf swing or a left-handed golf swing, depending upon the preference of the wearer. In an alternative embodiment, the bifocal element may be placed in both lenses provided that the near vision segment is positioned in the upper outermost temporal portion of the lenses. FIG. 4 shows an alternative embodiment where both lenses in a pair of glasses have the bifocal elements.

U.S. Pat. No. 4,484,804 describes a multifocal ophthalmic lens, such as a bifocal lens, in which the convex front surface includes an upper part for distant vision having a first spherical surface and a lower part for reading having a second spherical surface, the radius of the first spherical surface being greater than the radius of the second spherical surface. A zone of curvature continuity connects the first and second spherical surfaces along at least one meridian, e.g., a central meridian, of the ophthalmic lens, and the second spherical surface extends away from the zone of surface continuity into a surface of revolution which may be spherical or toroidal. Junctions between the surfaces are defined by ledgeless intersections which are lines of curvature discontinuity extending away from the zone of surface continuity. In case of trifocal lenses, a third crescent-shaped spherical surface, having a radius of length intermediate the radii of the first and second spherical surfaces, is interposed between the first and second spherical surfaces.

### SUMMARY OF THE INVENTION

A non-progressive ophthalmic lens used in eye frames is provided with at least two and preferably only two distinct areas of prescription. A very large (in proportion and as a percentage with respect to other areas of the lens) lower area (lower relative to the face and eyes of the wearer) is provided with intermediate or near distance vision correction prescription. A smaller, top portion of the lens is provided with a stable power, containing the wearer's prescription (or non-prescription of zero power) for distance vision correction. In the preferred embodiment, the two powers meet at a lined intersection to minimize or eliminate any lens area being wasted by a progressive joining or blending of the two powers.

### BRIEF DESCRIPTION OF THE FIGURES

FIG. 1 shows a non-progressive lens having two distinct power portions comprising a top distance vision correction and a lower near to intermediate power correction.

FIG. 2 shows a glass frame with two multifocal lenses provided therein.

FIG. 3 shows prescription orientation on a lens to assist in reduction of prism jump according to a practice described herein.

FIG. 4 shows a perspective view of the lens of FIG. 3.

### DETAILED DESCRIPTION OF THE INVENTION

A significant disadvantage to the use ophthalmic lenses is a difficulty in resting the eyes and making transitions from the intense near and intermediate viewing of the keyboard and screen to a more distant view. The difficulty is complicated where a worker has no need or little need of a prescription at one of the distinct distance areas of viewing. A very good lens design for prepresbyopes has therefore been found to be a lens that has the majority of the viewing area as a single vision near to intermediate vision correction/non-correction and a slice at the very top of the viewing area that contains the distance viewing prescription. The lens surfaces comprising the two prescriptions are positioned along a common centerline so as to reduce or eliminate the image jump that occurs in many bifocal lens designs when the view is shifted from the intermediate viewing portion to the distance viewing portion.

Reference to the Figures will assist in an appreciation of the described technology.

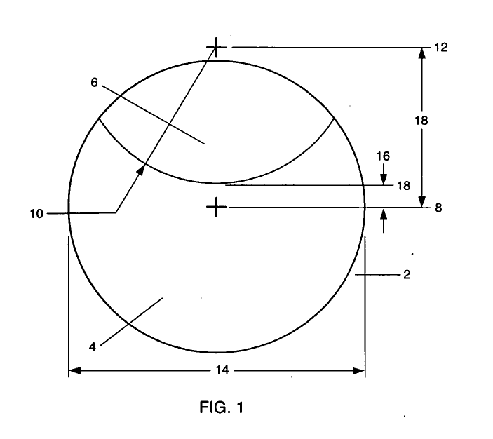

FIG. 1 shows a lens 2 according to the presently described technology. The lens 2 is shown as circular, with a center 8 and a diameter 14 of 75 mm. The lens 2 comprises an intermediate power area 4 and a distance power area 6. The center 12 of the circular distance power area 6 is shown for instructional purposes, and has a radius 10 of 35 mm. The distance 18 between the centers 8, 12 of the circles of the two lens areas 4, 6 are shown, as is the distance 16 between the lowest point 18 of the arc of the distance power area 6 and the center 8 of the circle defining the intermediate power area 4. The shapes and dimensions are specified for purposes of convenience and not for limitation of the practice of the invention.

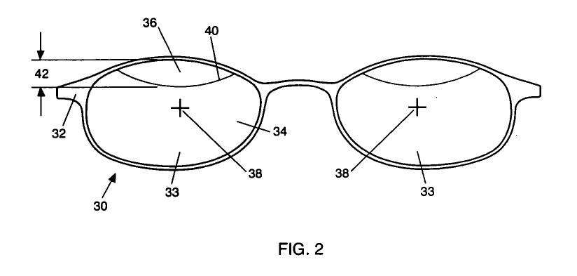

FIG. 2 shows an eyeglass set 30 comprising a frame 32 with two multifocal lenses 33 provided therein. One lens has an intermediate vision prescription area 34 and a distance vision correction prescription area 36. The two areas 34 and 36 and shown with a separation or segmentation line 40 that would be visible with non-progressive lenses. The fitting crosses 38 are also displayed. In one potential commercial embodiment, the distance power area 36 would be provided as standard corrections of 0, 0.50, 0.75, 1.00, 1.25, 1.50, 1.75 and 2.00 diopters, or any selected combinations and sub-combinations thereof. In this way, a minimum number of distance correcting segments can be provided to the optometrist for combination with the intermediate area 34 segments. It is of course possible to provide an unlimited number of powers and corrective features in the various lens segments, but for commercial facility and potential off-the-shelf purchase, limiting the prescriptions and combinations of prescriptions to the most common combinations is a simple approach. In FIG. 2, the vertical dimension 42 of the distance correction prescription area is about 7 mm of the entire 29 mm height of the lens 33.

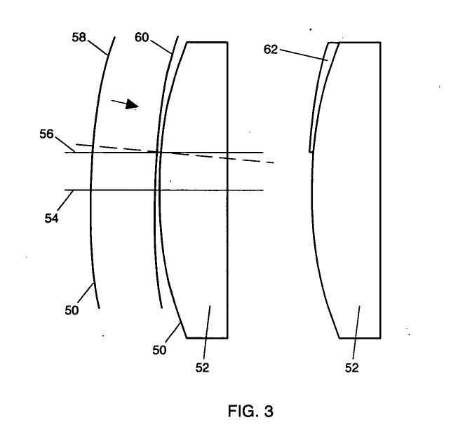

There are a number of possible methods of designing the intersection of the powers on the multi-focal, especially bifocal, lens. As one potential embodiment, FIG. 3 shows prescription orientation on a lens 52 to assist in reduction of prism jump according to a practice described herein. The surface 50 of the lens 52 is shown relative to placing the virtually displayed refractive power 58 centerline and the virtually displayed dioptic power 60 centerline on the same axis. The the ledge height can be varied during prototyping in order to find the offset between the two power areas that results in the most cosmetically appealing design. The result of this alignment is shown with the dioptic power area 62 shown over the lens 52.

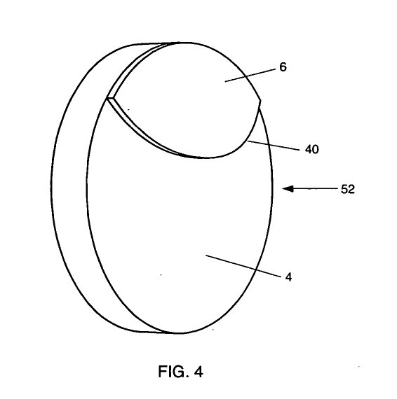

FIG. 4 shows a perspective view of the lens of FIG. 3. The lens 52 is shown with the differentiated intermediate vision correction area 4, the distance vision correction area 6 and the segmenting line 40.

The percentage of the total area provided as the distance vision correcting area may be varied among a range judged to be most suitable for the user. The distance correction area should be less than 40% of the total lens area, less than 35% is particularly desirable, and less than 30% of the area is highly useful. The area should be greater than 10% of the entire lens area, greater than 15%, and greater than 20% is highly useful. Working ranges of the percentage of total lens surface area that acts as a distance correcting lens segment in constructions for providing commercial lenses might include, for example, 10-40% distance/intermediate area, 10-35%, 15-35%, 15-30%, 10-30%, 20-35%, 20-30%, and 25-35%.

Any conventional or new lens materials can be used as the substance of the lens, including, but not limited to preferred classes of glass, polymers, thermoplastic polymers, thermoset or cured polymers, and the like. Preferred polymers include polycarbonate resin, polyester resins, polysulfone resins and polyacrylate resins. The lenses may be cast, injection molded, thermoformed, milled, laminated, ground or the like. Additional functionality may be provided in the lens structure and materials by known manufacturing techniques. For example, photochromic layers and properties may be provided, polarized layers and functions may be provided, tinted lenses may be provided, and the like, by known techniques.

The lens may be fit at the center pupil, which will provide the patients between approximately 5 and 7 mm (usually about 6 mm) of upward gaze movement before their view passes into the distance vision correcting area. In use, the wearer would spend the majority of time looking through the optical center at the computer screen or at the reading material at the near or intermediate distance. Whenever the wearer needs to see at a distance, they simply tilt their head down and look through the distance vision correcting area at the top of the lens. This would provide full distance vision to those who have the distance vision correcting prescription in the top of the lens. Even using a fixed selection of commercial prescriptions for the distance vision correcting area (e.g., the range indicated above of other sets of prescriptions that are provided), the majority of wearers can be assisted, and even if the prescription for the distance vision correction area does not meet the strength of the wearer's normal prescription, at least some improvement is provided. Typical, but not exclusive ranges of specifications provided in the lenses could, by way of non-limiting examples, include a prescription range of −5.00 diopters to +7.50 diopters (measured at the fitting cross), base curves of 2.50, 5.50 and 8.00, the additional power areas of 0, +0.50D, +0.75D, +1.00D, +1.25D, +1.50.D and +1.75D, and blank sizes of from 50-100 mm diameters, or even only 75 mm diameter.

Although specific values, powers, materials, and shapes have been described and shown in this disclosure, except where specific limitations to these are provided in the claims, the disclosure is intended to be provided as species exemplifying the broadest generic concepts envisioned within the practice of this technology. The examples are not intended to limit the scope of the invention.

What is claimed:

1. A multifocal spectacle lens having a large near-to-intermediate vision part comprising 60-90% of total spectacle lens surface area, the spectacle lens comprising:
a base lens dimensioned for the near-vision range, said base lens having an outer surface facing objects to be viewed;
a supplementary lens function attached to a top area of the base lens, the supplementary lens function providing a distance vision correction prescription that provides distinct segments on the multifocal lens for a distance-vision range at the top of the multifocal lens and a near-to-intermediate range.

2. The multifocal spectacle lens of claim 1 wherein the supplementary lens function is a lens segment inserted into a space provided at the top of the base lens.

3. The multifocal spectacle lens of claim 1 wherein the supplemental function is a lens segment applied over a surface of the base lens.

4. The multifocal lens of claim 1 wherein there are two non-progressive lens segments fit together within a spectacle frame.

5. The multifocal lens of claim 1 wherein there are two non-progressive lens segments fused together at edges of each segment within a spectacle frame.

6. The multifocal lens of claim 1 wherein there are two non-progressive lens segments adhesively secured together at edges of each segment within a spectacle frame.

7. The multifocal lens of claim 1 wherein the distance vision correction prescription covers from 10-40% of total viewing area of the multifocal lens

8. The multifocal lens of claim 1 wherein the distance vision correction prescription covers from 15-40% of total viewing area of the multifocal lens

9. The multifocal lens of claim 1 wherein the distance vision correction prescription covers from 15-35% of total viewing area of the multifocal lens

10. The multifocal lens of claim 1 wherein the distance vision correction prescription covers from 20-35% of total viewing area of the multifocal lens

11. A method of providing multifocal lenses to a wearer comprising completing a base lens with near vision correcting prescription, selecting a prescription lens segment for distance vision correction, and attaching the prescription lens segment for distance vision correction to an upper position, relative to eyes of a lens wearer, on the base lens.

12. The method of claim 11 wherein selecting is done from among at least three different lens segments with different distance vision correction prescriptions.

13. The method of claim 12 wherein the at least three different distance vision correction prescriptions are selected from the group consisting of +0.50D, +0.75D, +1.00D, +1.25D, +1.50.D and +1.75D.

14. The method of claim 11 wherein the distance vision correction prescription covers from 10-40% of total viewing area of the multifocal lens

15. The method of claim 12 wherein the distance vision correction prescription covers from 10-40% of total viewing area of the multifocal lens

16. The method of claim 13 wherein the distance vision correction prescription covers from 10-40% of total viewing area of the multifocal lens
